(19) United States
(12) Patent Application Publication
(10) Pub. No.: US 2014/0212350 A1
(43) Pub. Date: Jul. 31, 2014

(54) AMMONIA OXIDATION CATALYST

(71) Applicant: JOHNSON MATTHEY PUBLIC LIMITED COMPANY, LONDON (GB)

(72) Inventors: PAUL JOSEPH ANDERSEN, PLYMOUTH MEETING, PA (US); KEVIN DOURA, PLAINSBORO, NJ (US)

(73) Assignee: JOHNSON MATTHEY PUBLIC LIMITED COMPANY, LONDON (GB)

(21) Appl. No.: 14/165,772

(22) Filed: Jan. 28, 2014

Related U.S. Application Data
(60) Provisional application No. 61/757,927, filed on Jan. 29, 2013.

(51) Int. Cl. B01J 23/652; B01D 53/58

(52) U.S. Cl. CPC B01J 23/6527; B01D 53/58
USPC 423/237; 502/350; 502/309; 502/333; 422/170

(57) ABSTRACT

A catalyst article for treating an emission gas is provided comprising (a) a first catalyst layer having a plurality of consecutive sub-layers, wherein each sub-layer includes vanadium on a first refractory metal oxide support selected from alumina, titania, zirconia, ceria, silica, and mixtures of these; (b) a second catalyst layer comprising one or more noble metals disposed on a second refractory metal oxide support; and (c) a substrate, wherein the first and second catalyst layers are on and/or within the substrate.

### BACKGROUND

1. Field of Invention

Provided is an oxidation catalyst for treating combustion exhaust gas, and particularly for reducing ammonia slip associated with a selective catalytic reduction process.

2. Description of Related Art

Combustion of hydrocarbon-based fuel in electrical power stations and in engines produces flue or exhaust gas that contains, in large part, relatively benign nitrogen (N₂), water vapor (H₂O), and carbon dioxide (CO₂). But the flue and exhaust gases also contains, in relatively small part, noxious and/or toxic substances, such as carbon monoxide (CO) from incomplete combustion, hydrocarbons (HC) from un-burnt fuel, nitrogen oxides (NOₓ) from excessive combustion temperatures, and particulate matter (mostly soot). To mitigate the environmental impact of flue and exhaust gas released into the atmosphere, it is desirable to eliminate or reduce the amount of the undesirable components, preferably by a process that, in turn, does not generate other noxious or toxic substances.

Typically, flue gases from electrical power stations and exhaust gases lean burn gas engines have a net oxidizing effect due to the high proportion of oxygen that is provided to ensure adequate combustion of the hydrocarbon fuel. In such gases, one of the most burdensome components to remove is NOₓ, which includes nitric oxide (NO), nitrogen dioxide (NO₂), and nitrous oxide (N₂O). The reduction of NOₓ to N₂ is particularly problematic because the exhaust gas contains enough oxygen to favor oxidative reactions instead of reduction. Notwithstanding, NOₓ can be reduced by a process commonly known as Selective Catalytic Reduction (SCR). An SCR process involves the conversion of NOₓ, in the presence of a catalyst and with the aid of a nitrogenous reducing agent, such as ammonia, into elemental nitrogen (N₂) and water. In an SCR process, a gaseous reductant such as ammonia is added to an exhaust gas stream prior to contacting the exhaust gas with the SCR catalyst. The reductant is absorbed onto the catalyst and the NO reduction reaction takes place as the gases pass through or over the catalyzed substrate. The chemical equation for stoichiometric SCR reactions using ammonia is:

4NO+4NH₃+O₂→4N₂+6H₂O

2NO₂+4NH₃+O₂→3N₂+6H₂O

NO+NO₂+2NH₃→2N₂+3H₂O

Most SCR processes utilize a stoichiometric excess of ammonia in order to maximize the conversion of NOx. Unreacted ammonia that passes through the SCR process (also referred to as “ammonia slip”) is undesirable, because the released ammonia gas can negatively impact the atmosphere and can react with other combustion species. To reduce ammonia slip, SCR systems can include an ammonia oxidation catalyst (AMOX) (also known as an ammonia slip catalyst (ASC)) downstream of the SCR catalyst.

Catalysts for oxidizing excess ammonia in an exhaust gas are known. For example, U.S. Pat. No. 7,393,511 describes an ammonia oxidation catalyst containing a precious metal, such as platinum, palladium, rhodium, or gold on a support of titania alumina, silica, zirconia, etc. Other ammonia oxidation catalyst contain a first layer of vanadium oxide, tungsten oxide, and molybdenum oxide on a titania support, and a second layer of platinum on a titania support (see, e.g., U.S. Pat. No. 8,202,481 and U.S. Pat. No. 7,410,626). However, these catalysts are not highly efficient at converting ammonia, particularly at relatively low temperatures. Accordingly, there remains a need in the art for improved ammonia slip catalysts. The present invention satisfies this need among others.

### SUMMARY OF THE INVENTION

The present invention, in part, pertains to a heterogeneous oxidation catalyst that is particularly effective at reducing ammonia slip when used downstream of an SCR process. When disposed on a substrate, the oxidation catalyst comprises at least two layers: a first layer containing multiple, consecutive sub-layers of a vanadium-based catalyst, and a second layer containing a noble metal catalyst. The first layer is preferably formed by applying multiple coatings of the vanadium catalyst to the substrate. Applicants have surprisingly found these multiple sub-layers significantly improves the material's selectivity for reacting with ammonia instead of NOₓ, particularly at high temperatures, compared to a catalyst having a comparable amount of vanadium arranged as a single layer. The novel catalyst of the present invention is capable of improving selectivity of NOₓ by about 50% to about 75% compared to conventional catalyst without sub-layers.

Accordingly, provided is a catalyst article for treating an emission gas comprising (a) a first catalyst layer having a plurality of consecutive sub-layers, wherein each sub-layer includes vanadium on a first refractory metal oxide support selected from alumina, titania, zirconia, ceria, silica, and mixtures of these; (b) a second catalyst layer comprising one or more noble metals disposed on a second refractory metal oxide support; and (c) a substrate, wherein the first and second catalyst layers are on and/or within the substrate.

According to another aspect of the invention, provided is a method for preparing a catalyst article comprising the steps of (a) coating a substrate with a bottom catalyst layer comprising noble metal on a second refractory metal oxide support; (b) coating said substrate with a top catalyst sub-layer comprising vanadia on a first refractory metal oxide support; and (c) subsequent to step (b), coating said substrate with a consecutive catalyst top sub-layer comprising said vanadia on said first refractory metal oxide support, wherein said top sub-layers are applied over said bottom layer.

According to another aspect of the invention, provided is a catalyst article produced by a process comprising the steps of (a) coating a substrate with a bottom catalyst layer comprising noble metal on a second refractory metal oxide support; (b) coating said substrate with a top catalyst sub-layer comprising vanadia on a first refractory metal oxide support; and (c) subsequent to step (b), coating said substrate with a consecutive catalyst top sub-layer comprising said vanadia on said first refractory metal oxide support, wherein said top sub-layers are applied over said bottom layer.

According to another aspect of the invention, provided is a method for treating an emission gas comprising the steps of (a) contacting a emission gas derived combusting hydrocarbons in a stoichiometric excess of oxygen, wherein the emission gas contains ammonia, with a catalyst article according to any of claims 1-9; and (b) oxidizing a least a portion of said ammonia to form N₂ and/or NOₓ.

According to yet another aspect of the invention, provided is a system for treating an emission gas comprising an SCR catalyst and an ammonia slip catalyst described herein.

### BRIEF DESCRIPTION OF THE DRAWINGS

FIGS. 1A-1E are drawings of catalyst articles according to certain embodiments of the present invention;

FIG. 2 is a graph depicting NH₃ conversion relative to temperature for an embodiment of the present invention;

FIG. 3 is a graph depicting NOₓ selectivity relative to temperature for an embodiment of the present invention; and

FIG. 4 is a graph depicting overall NH₃ and NOₓ concentration output for an embodiment of the present invention.

### DETAILED DESCRIPTION OF PREFERRED EMBODIMENTS OF THE INVENTION

In a preferred embodiment, the invention is directed to a catalyst article for improving environmental air quality, particularly for improving flue or other exhaust gas emissions generated by power plants, gas turbines, lean burn internal combustion engines, and the like. Emissions are improved, at least in part, by reducing the concentrations of NH₃ and/or NOₓ in the exhaust gas over a broad operational temperature range. Useful catalyst articles include those that preferentially oxidize ammonia and/or reduce NOₓ in an oxidative environment.

In certain preferred embodiments, the catalyst article comprises a substrate, a first catalytic layer on the substrate, wherein the first catalyst layer has a plurality of consecutive sub-layers containing a supported vanadium-based catalyst, and a second catalytic layer on the substrate containing a supported noble metal catalyst. As used herein, the term “consecutive” with respect to the sub-layers means that each sub-layer is contact with its adjacent sub-layer(s) and that the sub-layers as a whole are arranged one on top of another on the substrate. As used herein the terms “first layer” and “second layer” are used to describe the relative positions of catalyst layers in the catalyst article with respect to the normal direction of exhaust gas flow through, past, and/or over the catalyst article. Under normal exhaust gas flow conditions, exhaust gas contacts the first layer prior to contacting the second layer. In certain embodiments, the second layer is applied to an inert substrate as a bottom layer and the first layer is top layer that is applied over the second layer as a consecutive series of sub-layers. In such embodiments, the exhaust gas penetrates (and hence contacts) the first layer, before contacting the second layer, and subsequently returns through the first layer to exit the catalyst component. In other embodiments, the first layer is a first zone disposed on an upstream portion of the substrate and the second layer is disposed on the substrate as a second zone, wherein the second zone is downstream of the first.

The first catalyst layer preferably contains vanadium on a first support, preferably comprising a first refractory metal oxide. In certain embodiments, the form of vanadium is free vanadium, vanadium ion, or an oxide of vanadium or a derivative thereof. Preferably, the form of vanadium is vanadia (V₂O₅). In addition to vanadium, the sub-layers can include other catalytically active metal oxides such as oxides of tungsten and/or oxides of molybdenum. As used herein, a “catalytically active” metal oxide is one that directly participates as a molecular component in the catalytic reduction of NOₓ and/or oxidization of NH₃ or other nitrogenous-based SCR reductants. By corollary, a “catalytically inactive” metal oxide is one which does not directly participate as a molecular component in the catalytic reduction of NOₓ and/or oxidization of NH₃ or other nitrogenous-based SCR reductants. In certain embodiments, an oxide of vanadium is present in a majority amount relative to other catalytically active metal oxides, such as tungsten oxides. In certain other embodiments, oxides of vanadium are present in a minority amount relative to other catalytically metal oxides, such as tungsten oxides.

Preferably, the catalyst layer containing vanadium is substantially free of noble metals. By “substantially free” is it meant that the relevant metal is not present in the layer in an amount that would affect the performance of the catalyst layer. In certain embodiments, a layer that has a first metal and that is “substantially free” of a second metal means that the layer has less than 5 weight percent of the second metal, relative to the first metal, preferably less than 1 weight percent, and even more preferably less than 0.1 weight percent.

The vanadium is disposed on a high-surface area support that is suitable for use in high temperature heterogenic catalyst applications. The support preferably has a pore volume of about 0.1-0.5 g/cc, for example about 0.2-0.4 g/cc, preferably measured by mercury intrusion porosimetry. In certain embodiments, the supports have wide pores (e.g., 100-350 Å) or both wide and narrow pores. In certain embodiments, the support has a BET surface area of at least 50 m²/g, preferably about 50-500 m²/g, more preferably about 50-300 m²/g, or about 150-250 m²/g. Preferred support materials include refractory metal oxides such as alumina, titania, zirconia, ceria, non-zeolite silica-alumina, and mixtures of these, with supports comprising titania being more preferred. Refractory metal oxide includes both single metal oxides and mixed metal oxides. Preferably, the support material is a catalytically inactive metal oxide.

In certain embodiments, the support material for the vanadium component is titania or titania in combination with another component such as tungsten (VI) oxide, molybdenum oxide, or silica as a mixture or as a mixed oxide. While both vanadia and the support can both be metal oxides, the two components are structurally distinct from each other in that the support is present as discrete particles and the vanadia is present in a relatively thin layer or coating that adheres to the particles. Thus, the vanadia and titania are not present as a mixed oxide.

The mean particle size, based on the particle count, of the support material is preferably about 0.01-10 μm, for example about 0.5-5 μm, about 0.1-1 μm, or about 5-10 μm, and preferably has a majority of the particle count within one of these ranges. In other embodiments, the high surface area support is an aluminosilicate, silico-aluminophosphate, or aluminophosphate molecular sieve, such as a zeolite, preferably having a framework of BEA, MFI, CHA, AEI, LEV, KFI, MER, RHO, or ERI, or an intergrowth of two or more of these.

The layer containing vanadium is preferably deposited on the substrate as multiple sub-layers, for example as two, three, or more sub-layers. The substrate can be an uncoated substrate, a substrate previously coated with another catalyst layer or zone, such as PGM catalyst layer, or an extruded catalytic body. Preferably, the multiple layers of vanadium-based catalyst are applied to the substrate as discrete sub-layers to form an overall stratified catalyst layer containing vanadium. According to such embodiments, a first sub-layer is preferably applied over the surface of the substrate, and additional sub-layers are subsequently applied over the preceding sub-layer. Such a catalyst article is structurally different than a catalyst article containing a comparable amount of vanadium-based catalyst applied as a single layer, as evidence at least in part by the relative increase in NH₃ selectivity of the present invention.

In certain embodiments, the vanadium-based catalyst is molecularly dispersed among the sub-layers. As used herein, the term “molecularly dispersed” with respect to vanadium in the sub-layers means that, in general, the vanadium is evenly distribution between each of the sub-layers. For example, in certain embodiments, each sub-layer comprises an equivalent amount of vanadium ±about 25 weight percent. That is, each of the sub-layers will contain an amount of vanadium that is within about 25 weight percent of the vanadium content of each of the other sub-layers. In certain embodiments, each sub-layer will have comprise an equivalent amount of vanadium ±15 wt. %, more preferably about ±5 wt. %, and even more preferably about ±1 wt. % compared to the amount of the vanadium in each of the other sub-layers. In certain embodiments, the first layer contains an amount of vanadium (x) that is distributed among a certain number (n) of stratified zones (Z), wherein n equals 2 to 10. The amount of vanadium in each zone (Zᵢ) is within a range from ([x/n]*A) to ([x/n]*B), wherein A is 0.75, B is 1.25. In certain embodiments, A is 0.85, 0.95, or 0.99, and B is 1.15, 1.05, or 1.01.

The second catalyst layer preferably comprises a noble metal, preferably a noble metal supported by a second refractory metal oxide. Examples of suitable noble metals include ruthenium, rhodium, palladium, silver, osminum, iridium, platinum, and gold, and combinations thereof, with platinum group metals being preferred, particularly platinum, palladium, and combinations thereof.

The noble metal is disposed on a high-surface area support that is suitable for use in high temperature heterogenic catalyst applications. The support preferably has a pore volume of about 0.1-0.5 g/cc, for example about 0.2-0.4 g/cc, preferably measured by mercury intrusion porosimetry. In certain embodiments, the supports have wide pores (e.g., 100-350 Å) or both wide and narrow pores. In certain embodiments, the support has a BET surface area of at least 50 m²/g, preferably about 50-500 m²/g, more preferably about 50-300 m²/g, or about 150-250 m²/g. Preferred support materials include refractory metal oxides such as alumina, titania, zirconia, ceria, non-zeolite silica-alumina, and mixtures of these. In certain embodiments, the support material for the noble metal component is alumina, titania, or titania in combination with another component including tungsten (VI) oxide. Refractory metal oxide includes both single metal oxides and mixed metal oxides. Preferably, the support material is a catalytically inactive metal oxide. The mean particle size, based on the particle count, of the support material is preferably about 0.01-10 μm, for example about 0.5-5 μm, about 0.1-1 μm, or about 5-10 μm, and preferably has a majority of the particle count within one of these ranges.

In other embodiments, the high surface area support is an aluminosilicate, silico-aluminophosphate, or aluminophosphate molecular sieve, such as a zeolite, preferably having a framework of BEA, MFI, CHA, AEI, LEV, KFI, MER, RHO, or ERI, or an intergrowth of two or more of these.

Typical applications using the catalysts layers of the present invention involve heterogeneous catalytic reaction systems (i.e., solid catalyst in contact with a gas reactant). To improve contact surface area, mechanical stability, and fluid flow characteristics, the supported catalysts can be disposed on and/or within a substrate. In certain embodiments, a washcoat containing the supported noble metal catalyst and a washcoat containing the supported vanadium catalyst is applied to an inert substrate, such as corrugated metal plate or a honeycomb cordierite brick. Alternatively, the noble metal catalyst is kneaded along with other components such as fillers, binders, and reinforcing agents, into an extrudable paste which is then extruded through a die to form a honeycomb brick. The vanadium catalyst is then applied as multiple sub-layers to the brick, before or after drying and/or calcining.

The washcoat comprising the vanadium component or the noble metal component is preferably a solution, suspension, or slurry. Suitable coatings include surface coatings, coating that penetrate a portion of the substrate, coatings that permeate the substrate, or some combination thereof. The vanadium layer preferably contain vanadia in a total amount of about 0.1-10 weight percent based on the weight of the refractory metal oxide support, more preferably about 0.5-5 weight percent. The noble metal coating preferably contains about 0.05-0.50 weight percent noble metal based on the weight of the refractory metal oxide support. A washcoat can also include non-catalytic components, such as fillers, binders, stabilizers, rheology modifiers, and other additives, including one or more of alumina, silica, non-zeolite silica alumina, titania, zirconia, ceria. In certain embodiments, the catalyst composition may comprise pore-forming agents such as graphite, cellulose, starch, polyacrylate, and polyethylene, and the like. These additional components do not necessarily catalyze the desired reaction, but instead improve the catalytic material's effectiveness, for example by increasing its operating temperature range, increasing contact surface area of the catalyst, increasing adherence of the catalyst to a substrate, etc. Typically, metal oxide particles used as binders are distinguishable over metal oxide particles used as supports based on particle size, with the binder particles being significantly larger relative to support particles. The first coating layer is preferably applied to the substrate in an amount sufficient to produce a washcoat loading of about 10-300 g/ft³ of noble metal, more preferably about 20-150 g/ft³, and even more preferably about 50-100 g/ft³. The second layer coating is preferably applied to the substrate as multiple sub-layers that produce a total vanadium washcoat loading >0.25 g/in³, such as >0.50 g/in³, or >0.80 g/in³, e.g. 0.80 to 3.00 g/in³. In preferred embodiments, the washcoat loading is >1.00 g/in³, such as >1.2 g/in³, >1.5 g/in³, >1.7 g/in³ or >2.00 g/in³ or for example 1.5 to 2.5 g/in³.

Two of the most common substrate designs are plate and honeycomb. Preferred substrates, particularly for mobile applications, include flow-through monoliths having a so-called honeycomb geometry that comprise multiple adjacent, parallel channels that are open on both ends and generally extend from the inlet face to the outlet face of the substrate and result in a high-surface area-to-volume ratio. For certain applications, the honeycomb flow though monolith preferably has a high cell density, for example about 600 to 800 cells per square inch, and/or an average internal wall thickness of about 0.18-0.35 mm, preferably about 0.20-0.25 mm. For certain other applications, the honeycomb flow through monolith preferably has a low cell density of about 150-600 cells per square inch, more preferably about 200-400 cells per square inch. Preferably, the honeycomb monoliths are porous. In addition to cordierite, silicon carbide, silicon nitride, ceramic, and metal, other materials that can be used for the substrate include aluminum nitride, silicon nitride, aluminum titanate, α-alumina, mullite e.g. acicular mullite, pollucite, a thermet such as Al₂OsZFe, Al₂O₃/Ni or B₄CZFe, or composites comprising segments of any two or more thereof. Preferred materials include cordierite, silicon carbide, and alumina titanate.

Plate-type catalysts have lower pressure drops and are less susceptible to plugging and fouling than the honeycomb types, but plate configurations are much larger and more expensive. Honeycomb configurations are smaller than plate types, but have higher pressure drops and plug more easily. In certain embodiments the plate substrate is constructed of metal, preferably corrugated metal.

In certain embodiments, the invention is a catalyst article made by a process described herein. In a particular embodiment, the catalyst article is produced by a process that includes the steps of applying a noble metal catalyst composition, preferably as a washcoat, to a substrate as a bottom layer and subsequently applying a top layer comprising two or more sub-layers of a vanadium catalyst, preferably as a washcoat, to the substrate. Each vanadium sub-layer can be applied to the refractory metal oxide support by any technique known in the art. In one embodiment, a vanadium solution and titania slurry are mixed together, coated on a substrate, dried and then calcined. That process is then repeated to form the multiple sub-layers.

The catalyst article of the present invention is structurally different than a catalyst article containing a comparable amount of vanadium-based catalyst applied as a single layer. In certain embodiments, evidence of this structural difference is demonstrated by the superior performance in NOₓ selectivity, NH₃ conversion, and overall reduction in NOₓ+NH₃ emissions. Regarding NOₓ selectivity, a catalyst article having multiple sub-layers of vanadia shows a remarkable increase in N₂ selectivity compared NOₓ selectivity at temperatures above 340° C. For example, at temperatures from about 350° C. to about 450° C., the present catalyst article can achieve about 35% to 65% conversion of NH₃ with almost no selectivity for NOₓ. At temperature above 450° C., the present catalyst article continues to have a high conversion of NH₃ (e.g., above 60%) and still shows a much higher selectivity for N₂ compared to the selectivity for NOₓ. In certain embodiments, the catalyst article of the present invention has a selectivity for NOₓ on a relative scale that is about 50 to about 75 percentage points less than a catalyst article having a similar amount of vanadia, but wherein the vanadia is coated as a single layer.

Regarding overall reduction in NOₓ+NH₃ emissions, a catalyst article having multiple sub-layers of vanadia shows a significant decrease in emission compared to a catalyst article having a similar amount of vanadia, but wherein the vanadia is coated as a single layer. For example, in certain embodiments, the overall NOₓ+NH₃ emissions of the present catalyst article is 10 to 40 percent less than the overall NOₓ+NH₃ emissions of a catalyst article having a similar amount of vanadia, but wherein the vanadia is coated as a single layer.

In another embodiment, the catalyst article is produced by a process that includes the steps of applying a noble metal catalyst composition, preferably as a washcoat, to a substrate as a first zone, and subsequently applying two or more sub-layers of a vanadium catalyst, preferably as a washcoat, to the substrate as a second zone, wherein at least a portion of the first zone is downstream of the second zone.

To reduce the amount of space required for an exhaust system, individual exhaust components in certain embodiments are designed to perform more than one function. For example, applying an ASC catalyst to a wall-flow filter substrate instead of a flow-through substrate serves to reduce the overall size of an exhaust treatment system by allowing one substrate to serve two functions, namely reducing ammonia slip by the catalyst and removal of exhaust gas soot by the filter substrate. Accordingly, in certain embodiments, the substrate is a honeycomb wall-flow filter or partial filter. Wall-flow filters are similar to flow-through honeycomb substrates in that they contain a plurality of adjacent, parallel channels. However, the channels of flow-through honeycomb substrates are open at both ends, whereas the channels of wall-flow substrates have one end capped, wherein the capping occurs on opposite ends of adjacent channels in an alternating pattern. Capping alternating ends of channels prevents the gas entering the inlet face of the substrate from flowing straight through the channel and existing. Instead, the exhaust gas enters the front of the substrate and travels into about half of the channels where it is forced through the channel walls prior to entering the second half of the channels and exiting the back face of the substrate.

The substrate wall has a porosity and pore size that is gas permeable, but traps a major portion of the particulate matter, such as soot, from the gas as the gas passes through the wall. Preferred wall-flow substrates are high efficiency filters. Wall flow filters for use with the present invention preferably have an efficiency of least 70%, at least about 75%, at least about 80%, or at least about 90%. In certain embodiments, the efficiency will be from about 75 to about 99%, about 75 to about 90%, about 80 to about 90%, or about 85 to about 95%. Here, efficiency is relative to soot and other similarly sized particles and to particulate concentrations typically found in conventional diesel exhaust gas. For example, particulates in diesel exhaust can range in size from 0.05 microns to 2.5 microns. Thus, the efficiency can be based on this range or a sub-range, such as 0.1 to 0.25 microns, 0.25 to 1.25 microns, or 1.25 to 2.5 microns.

Porosity is a measure of the percentage of void space in a porous substrate and is related to backpressure in an exhaust system: generally, the lower the porosity, the higher the backpressure. Preferably, the porous substrate has a porosity of about 30 to about 80%, for example about 40 to about 75%, about 40 to about 65%, or from about 50 to about 60%.

The pore interconnectivity, measured as a percentage of the substrate's total void volume, is the degree to which pores, void, and/or channels, are joined to form continuous paths through a porous substrate, i.e., from the inlet face to the outlet face. In contrast to pore interconnectivity is the sum of closed pore volume and the volume of pores that have a conduit to only one of the surfaces of the substrate. Preferably, the porous substrate has a pore interconnectivity volume of at least about 30%, more preferably at least about 40%.

The mean pore size of the porous substrate is also important for filtration. Mean pore size can be determined by any acceptable means, including by mercury porosimetry. The mean pore size of the porous substrate should be of a high enough value to promote low backpressure, while providing an adequate efficiency by either the substrate per se, by promotion of a soot cake layer on the surface of the substrate, or combination of both. Preferred porous substrates have a mean pore size of about 10 to about 40 μm, for example about 20 to about 30 μm, about 10 to about 25 μm, about 10 to about 20 μm, about 20 to about 25 μm, about 10 to about 15 μm, and about 15 to about 20 μm.

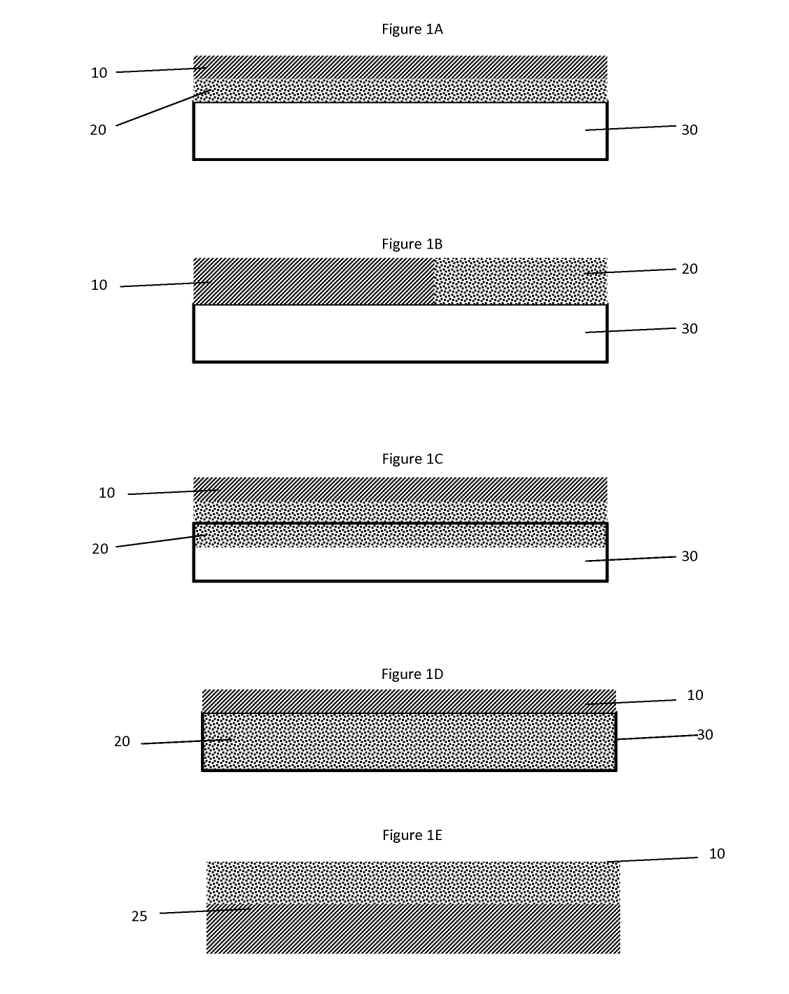

Turning to FIGS. 1A-1D, the first or second layers can be washcoated onto the substrate as continuous layers or in one or more zones corresponding to the axial length of the substrate or the inlet/outlet sides of the substrate filter. Preferably the first and second zones are adjacent to, and in contact with, each other. In FIG. 1A, the first catalyst layer (20) and second catalyst layer (10) are coated on a flow-through substrate (30) along a majority, and preferably the entire, axial length of the substrate. In such embodiments, the two layers are in contact over a majority of their respective lengths, and preferably their entire lengths. In FIG. 1B, the first layer (20) is coated on a downstream portion of the substrate (30) and the second layer (10) is coated on an upstream portion of the substrate (relative to exhaust gas flow), provided that the two layers are in contact with each other, and optionally overlap a portion of their lengths. In certain other embodiments, the first or the second layers is coated on the entire axial length of the substrate, while the other layer is coated on either an upstream portion or a downstream portion of the substrate. For embodiments in which one or both layers are coated on only a portion of the substrate, the portion may be less than 25% of the axial length, less than half of the axial length, more than half of the axial length, or more than 75% of the axial length of the substrate. In FIG. 1C, the first layer (20) penetrates a portion of said substrate (30) and contains a second layer coating (30) over the first layer. In FIG. 1D, the first layer (20) completely permeates the substrate (30), and the second layer (10) is a surface coating on said substrate.

Coating on wall-flow filter are on the inlet and/or outlet side of the filter (relative to exhaust gas flow through the filter), preferably on the outlet side of the filter, particularly for embodiments that also incorporate a selective catalyst reduction (SCR) catalyst or soot oxidation catalyst on the upstream side of the filter.

In certain embodiments, the layer containing the noble metal is an extruded support. FIG. 1E shows an extruded support (25) and a layer (10) comprising a supported vanadium catalyst. In this embodiment, the layer (10) is a surface coating on said extruded support layer (25). Very generally, the production of an extruded solid body containing the noble metal and refractory metal oxide support involves blending the source of noble metal, the refractory metal oxide support, a binder, an optional organic viscosity-enhancing compound into an homogeneous paste which is then added to a binder/matrix component or a precursor thereof and optionally one or more of stabilized ceria, and inorganic fibers. The blend is compacted in a mixing or kneading apparatus or an extruder. The mixtures have organic additives such as binders, pore formers, plasticizers, surfactants, lubricants, dispersants as processing aids to enhance wetting and therefore produce a uniform batch. The resulting plastic material is then molded, in particular using an extrusion press or an extruder including an extrusion die, and the resulting moldings are dried and calcined. The organic additives are “burnt out” during calcinations of the extruded solid body. The vanadium containing catalyst is then washcoated or otherwise applied to the extruded solid body as one or more sub-layers that reside on the surface or penetrate wholly or partly into the extruded solid body. Alternatively, a prefixed vanadium/refractory metal oxide support can be added to the paste prior to extrusion.

Extruded solid bodies containing prefixed vanadium according to the present invention generally comprise a unitary structure in the form of a honeycomb having uniform-sized and parallel channels extending from a first end to a second end thereof. Channel walls defining the channels are porous. Typically, an external “skin” surrounds a plurality of the channels of the extruded solid body. The extruded solid body can be formed from any desired cross section, such as circular, square or oval. Individual channels in the plurality of channels can be square, triangular, hexagonal, circular etc. Channels at a first, upstream end can be blocked, e.g. with a suitable ceramic cement, and channels not blocked at the first, upstream end can also be blocked at a second, downstream end to form a wall-flow filter. Typically, the arrangement of the blocked channels at the first, upstream end resembles a checker-board with a similar arrangement of blocked and open downstream channel ends.

The binder/matrix component is preferably selected from the group consisting of cordierite, nitrides, carbides, borides, intermetallics, lithium aluminosilicate, a spinel, an optionally doped alumina, a silica source, titania, zirconia, titania-zirconia, zircon and mixtures of any two or more thereof. The paste can optionally contain reinforcing inorganic fibers selected from the group consisting of carbon fibers, glass fibers, metal fibers, boron fibers, alumina fibers, silica fibers, silica-alumina fibers, silicon carbide fibers, potassium titanate fibers, aluminum borate fibers and ceramic fibers.

The alumina binder/matrix component is preferably gamma alumina, but can be any other transition alumina, i.e. alpha alumina, beta alumina, chi alumina, eta alumina, rho alumina, kappa alumina, theta alumina, delta alumina, lanthanum beta alumina and mixtures of any two or more such transition aluminas. It is preferred that the alumina is doped with at least one non-aluminum element to increase the thermal stability of the alumina. Suitable alumina dopants include silicon, zirconium, barium, lanthanides and mixtures of any two or more thereof. Suitable lanthanide dopants include La, Ce, Nd, Pr, Gd and mixtures of any two or more thereof.

Sources of silica can include a silica sol, quartz, fused or amorphous silica, sodium silicate, an amorphous aluminosilicate, an alkoxysilane, a silicone resin binder such as methylphenyl silicone resin, a clay, talc or a mixture of any two or more thereof. Of this list, the silica can be SiO₂ as such, feldspar, mullite, silica-alumina, silica-magnesia, silica-zirconia, silica-thoria, silica-berylia, silica-titania, ternary silica-alumina-zirconia, ternary silica-alumina-magnesia, ternary-silica-magnesia-zirconia, ternary silica-alumina-thoria and mixtures of any two or more thereof. Alternatively, the silica can be derived from calcining tetramethyl ortho silicate (TMOS) added to the extrusion composition.

Suitable clays include fullers earth, sepiolite, hectorite, a smectite, a kaolin and mixtures of any two or more thereof, wherein the kaolin can be chosen from subbentonite, anauxite, hallo ysite, kaolinite, dickite, nacrite and mixtures of any two of more thereof; the smectite can be selected from the group consisting of montmorillonite, nontronite, vermiculite, saponite and mixtures of any two or more thereof; and the fullers earth can be montmorillonite or palygorskite (attapulgite). Preferably, the vanadium is dispersed throughout, and preferably evenly throughout, the entire extruded catalyst body.

Where any of the above extruded solid bodies are made into a wall-flow filter, the porosity of the wall-flow filter can be from 30-80%, such as from 40-70%. Porosity and pore volume and pore radius can be measured e.g. using mercury intrusion porosimetry.

In certain embodiments, the catalyst article of the present invention is part an emission gas treatment system wherein the catalyst article is disposed downstream of a source of a nitrogenous reductant. Examples of nitrogenous reductants include ammonia and ammonia hydrazine or any suitable ammonia precursor, such as urea ((NH₂)₂CO), ammonium carbonate, ammonium carbamate, ammonium hydrogen carbonate or ammonium formate. More preferably, the catalyst article is an ammonia slip catalyst disposed downstream of a selective catalytic reduction (SCR) catalyst. In such embodiments, the ammonia slip catalyst oxidizes at least a portion of any nitrogenous reductant that is not consumed by the selective catalytic reduction process. For example, in certain embodiments, the ammonia slip catalyst is disposed on the outlet side of a wall flow filter and an SCR catalyst is disposed on the upstream side of a filter. In certain other embodiments, the ammonia slip catalyst is disposed on the downstream end of a flow-through substrate and an SCR catalyst is disposed on the upstream end of the flow-through substrate. In other embodiments, the ammonia slip catalyst and SCR catalyst are disposed on separate bricks within the exhaust system. These separate bricks can be adjacent to, and in contact with, each other or separated by a specific distance, provided that they are in fluid communication with each other and provided that the SCR catalyst brick is disposed upstream of the ammonia slip catalyst brick.

Suitable SCR catalyst for the present invention include metal promoted molecular sieves, such as aluminosilicate, silico-aluminophosphate, or aluminophosphate molecular sieves, preferably having a framework of BEA, MFI, CHA, AEI, LEV, KFI, MER, RHO, or ERI, or an intergrowth of two or more of these. The molecular sieve preferably is promoted with a metal such as Ce, Cu, Fe, Co, and the like. Other suitable SCR catalysts include vanadia and/or tungsten oxide supported on zeolite, alumina, titania, silica, tungsten oxides, etc. In certain embodiments, the SCR catalyst and the ammonia slip catalyst described herein have different compositions.

In certain embodiments, ammonia is oxidized at a temperature of at least 100° C. In another embodiment, the ammonia is oxidized at a temperature from about 150° C. to 750° C. In a particular embodiment, the temperature range is from 175 to 550° C. In another embodiment, the temperature range is from 175 to 400° C. In yet another embodiment, the temperature range is 450 to 900° C., preferably 500 to 750° C., 500 to 650° C., 450 to 550° C., or 650 to 850° C.

According to another aspect of the invention, provided is a method for the reduction of NOₓ compounds and/or oxidation of NH₃ in a gas, which comprises contacting the gas with a catalyst described herein for a time sufficient to reduce the level of NOₓ compounds in the gas. Methods of the present invention may comprise one or more of the following steps: (a) accumulating and/or combusting soot that is in contact with the inlet of a catalytic filter; (b) introducing a nitrogenous reducing agent into the exhaust gas stream prior to contacting the catalytic filter, preferably with no intervening catalytic steps involving the treatment of NOₓ and the reductant; (c) generating NH₃ over a NOₓ adsorber catalyst, and preferably using such NH₃ as a reductant in a downstream SCR reaction; (d) contacting the exhaust gas stream with a DOC to oxidize hydrocarbon based soluble organic fraction (SOF) and/or carbon monoxide into CO₂, and/or oxidize NO into NO₂, which in turn, may be used to oxidize particulate matter in particulate filter; and/or reduce the particulate matter (PM) in the exhaust gas; (e) contacting the exhaust gas with one or more flow-through SCR catalyst device(s) in the presence of a reducing agent to reduce the NOx concentration in the exhaust gas; and (f) contacting the exhaust gas with an ammonia slip catalyst, preferably downstream of the SCR catalyst to oxidize most, if not all, of the ammonia prior to emitting the exhaust gas into the atmosphere or passing the exhaust gas through a recirculation loop prior to exhaust gas entering/re-entering the engine.

The method can be performed on an exhaust gas derived from a combustion process, such as from an internal combustion engine (whether mobile or stationary), a gas turbines for stationary, marine, or locomotive applications, and coal or oil fired power plants. The method may also be used to treat gas from industrial processes such as refining, from refinery heaters and boilers, furnaces, the chemical processing industry, coke ovens, municipal waste plants and incinerators, etc. In a particular embodiment, the method is used for treating exhaust gas from a gas turbine or a lean-burn engine.

In a further embodiment, an oxidation catalyst for oxidizing nitrogen monoxide in the exhaust gas to nitrogen dioxide can be located upstream of where the nitrogenous reductant is added into the exhaust gas. In one embodiment, the oxidation catalyst is adapted to yield a gas stream entering the SCR catalyst having a ratio of NO to NO₂ of from about 4:1 to about 1:3 by volume, e.g. at an exhaust gas temperature at oxidation catalyst inlet of 250° C. to 450° C. The oxidation catalyst can include at least one platinum group metal (or some combination of these), such as platinum, palladium, or rhodium, coated on a flow-through monolith substrate. In one embodiment, the at least one platinum group metal is platinum, palladium or a combination of both platinum and palladium. The platinum group metal can be supported on a high surface area washcoat component such as alumina, a zeolite such as an aluminosilicate zeolite, silica, non-zeolite silica alumina, ceria, zirconia, titania or a mixed or composite oxide containing both ceria and zirconia.

In a further embodiment, a suitable filter substrate is located between the oxidation catalyst and the ammonia slip catalyst. Filter substrates can be selected from any of those mentioned above, e.g. wall flow filters. Where the filter is catalyzed, e.g. with an oxidation catalyst of the kind discussed above, preferably the point of metering nitrogenous reductant is located between the filter and the ammonia slip catalyst. Alternatively, if the filter is uncatalyzed, the means for metering nitrogenous reductant can be located between the oxidation catalyst and the filter.

### EXAMPLES

### Example 1

### Catalyst Preparation

A first catalyst layer was prepared as follows: Deionized water and alumina washcoat having a d₅₀ of about 3.4-4.2 μm were mixed in a container using a high shear mixer. Succinic acid was slowly added to achieve a concentration of about 100 g/ft³ and the admixture was continuously stirred for at least 30 minutes. Palladium nitrate was added and the resulting admixture was stirred for an additional 60 minutes. Natrasol™ was added and the resulting slurry was mixed for 24 hours. The final washcoat was applied to a 200 cpsi cordierite substrate, dried, and then calcined at 500° C.

A second catalyst layer was prepared as follows: A titania slurry was prepared with Ludox® and aged for at least 25 hours. A vanadium/tungsten solution was prepared to the desired concentration. The aged titania slurry and vanadium/tungsten solution were then mixed together. The particle size and final pH were then recorded. The resulting washcoat, which had a V/W ratio of 50:7, was coated as a first sub-layer on the substrate over the palladium layer, dried and then calcined at 500° C. A second sub-layer of the vanadium washcoat was then applied to the substrate over the first sub-layer as described above; the resulting washcoated substrate was dried and then calcined again at 500° C. Each of the two sub-layers contained about 2 weight percent vanadia, based on the total weight of the washcoated layer before drying/calcining.

### Example 2

### NH₃ Conversion Performance

The NH₃ conversion performance of a catalyst prepared according to Example 1 was compared to a similar catalyst article, but with a single vanadia layer.

The comparative sample was prepared as follows: A first catalyst layer was prepared as follows: Deionized water and alumina washcoat having a d₅₀ of about 3.4-4.2 μm were mixed in a container using a high shear mixer. Succinic acid was slowly added to achieve a concentration of about 100 g/ft³ and the admixture was continuously stirred for at least 30 minutes. Palladium nitrate was added and the resulting admixture was stirred for an additional 60 minutes. Natrasol™ was added and the resulting slurry was mixed for 24 hours. The final washcoat was applied to a 200 cpsi cordierite substrate, dried, and then calcined at 500° C.

A second layer was prepared as follows: Deionized water was mixed with titania and Ludox®. The material was aged for at least 24 hours. The material had a d₅₀ of <5.0 μm and a d₉₀ of <10.0 μm. VANZAN® was added to achieve a suitable washcoat thickness. The resulting washcoat was applied over the palladium layer, dried, and calcined at 500° C. The washcoated substrate was then dip impregnated with a vanadia/tungsten solution, dried, and calcined. The second layer contained about 4 weight percent vanadia relative to the total weight of the washcoat applied as a second layer.

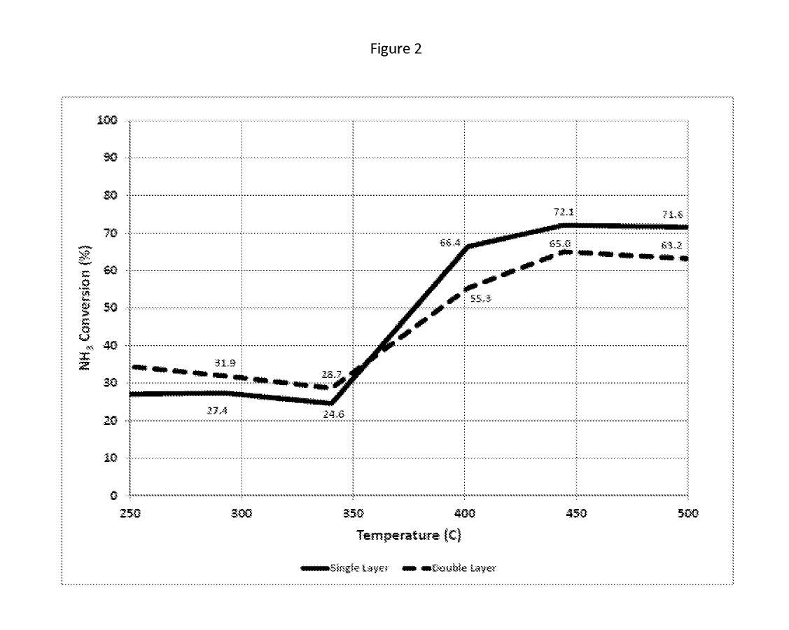

The catalyst component of Example 1 and the comparative catalyst component were then arranged as an ASC in a system having an upstream SCR catalyst. A simulated exhaust gas containing 40 ppm NH₃ and 30 ppm NOₓ, 15% O₂, 8% H₂O, 3% CO₂, 50 ppm C1-propene, and the remainder N₂ was passed through the catalyst components at a space velocity of about 20,000 hr⁻¹. The steady state catalytic activity of the components were evaluated at temperatures between 200 and 500° C. in increments of 50° C. Outlet products and conversion of reactants were monitored via FTIR. The results of these tests are provided in FIG. 2. Here, the catalyst containing multiple vanadia sub-layers showed a similar trend in NH₃ conversion to a catalyst with a single vanadia top layer, with a slight increase in low-temperature NH₃ conversion, particularly over a temperature range of about 250° C. to about 340° C., compared to the catalyst that had a single vanadia layer.

### Example 3

### NOₓ Selectivity Performance

The NOₓ selectivity performance of a catalyst prepared according to Example 1 was compared to a similar catalyst, but with a single vanadia layer under the same test conditions described in Example 2.

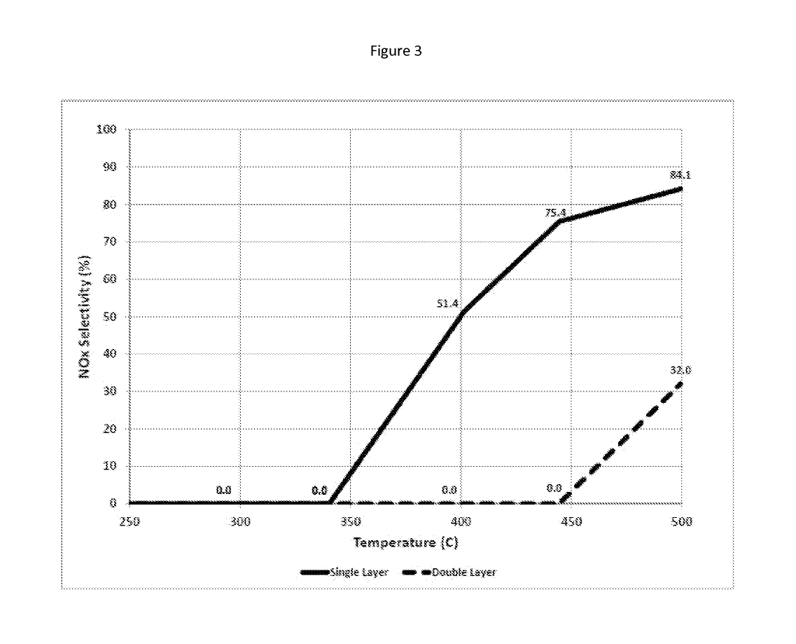

The results of these tests are provided in FIG. 3. Here, the catalyst containing multiple sub-layers of vanadia showed vastly lower NOₓ selectivity (higher N₂ selectivity) compared to the catalyst that did not have multiple vanadia layers. In particular, the catalyst having a single layer of vanadia showed a significant increase in selectivity toward NOₓ (and thus away from N₂) at temperatures above 350° C.

### Example 4

### Overall NH₃ and NOₓ Output

The overall concentration of NH₃ and NOₓ of a gas passed through a catalyst prepared according to Example 1 was compared to a similar catalyst, but with a single vanadia layer, under the same test conditions described in Example 2.

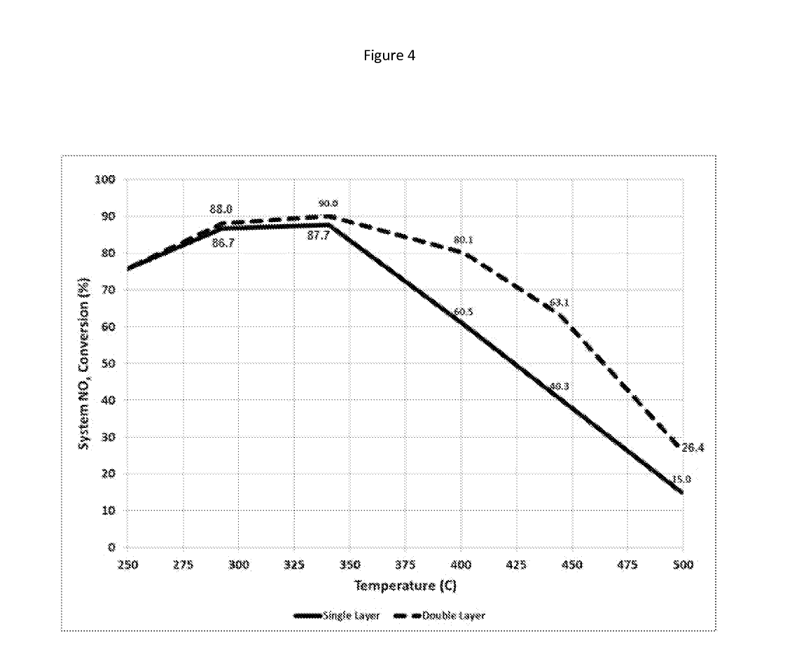

The results of these tests are provided in FIG. 4. Here, the catalyst containing the multiple vanadia sub-layers showed an overall reduction in NH₃+NOₓ concentration exiting the system compared to the catalyst that had a single vanadia layer.

1. A catalyst article for treating an emission gas comprising:
a. a first catalyst layer having a plurality of consecutive sub-layers, wherein each sub-layer includes vanadium on a first refractory metal oxide support selected from alumina, titania, zirconia, ceria, silica, and mixtures of these;
b. a second catalyst layer comprising one or more noble metals disposed on a second refractory metal oxide support; and
c. a substrate,
wherein the first and second catalyst layers are on and/or within the substrate.

2. The catalyst article of claim 1, wherein said vanadium is molecularly dispersed among the sub-layers.

3. The catalyst article of claim 1, wherein each of said sub-layers comprises an equivalent amount of vanadia +/−25%.

4. The catalyst article of claim 1, wherein said first layer contains about 10 to about 250 g/ft³ of vanadia.

5. The catalyst article of claim 1, wherein said vanadium is vanadia and the vanadia is present in an amount of about 0.1-10 weight percent based on the weight of the first refractory metal oxide support.

6. The catalyst article of claim 1, wherein said first layer comprises vanadia on a support comprising titania.

7. The catalyst article of claim 1, wherein said first layer comprises vanadia on a support comprising titania and an oxide of tungsten.

8. The catalyst article of claim 1, wherein said second layer comprises one or more platinum group metals selected from platinum and palladium on an alumina support, wherein said platinum group metal is present in an amount of about 0.05-0.50 weight percent based on the weight of the alumina support.

9. The catalyst article of claim 1, wherein said first layer comprises two of said consecutive sub-layers.

10. The catalyst article of claim 1, wherein the second layer is coated on the substrate as a bottom layer and the sub-layers are coated on the substrate as top layers, and said substrate is selected from a honeycomb brick, a wall-flow honeycomb filter, and a corrugated metal plate.

11. The catalyst article of claim 1, wherein the second layer is part of an extruded body and said first layer is coated on the extruded body.

12. The catalyst article of claim 1, wherein the first layer is coated on the substrate in a first zone and the second layer is coated on the substrate as a second zone, wherein the first zone is disposed upstream of the second zone relative to gas flow through the substrate.

13. The catalyst article of claim 1, wherein said substrate is a flow-through honeycomb brick and said first and second layers are coated on a downstream portion of said brick or said substrate is a wall-flow honeycomb filter and said first and second layers are coated on an outlet side of said filter.

14. The catalyst article of claim 1, wherein said substrate is a flow-through honeycomb brick and said first and second layers are coated on a downstream portion of said brick or said substrate is a wall-flow honeycomb filter and said first and second layers are coated on an outlet side of said filter, and said catalyst article further comprising an SCR catalyst coated an upstream portion of said flow-through honeycomb brick or coated on an inlet side of said filter.

15. A method for preparing a catalyst article comprising:
a. coating a substrate with a bottom catalyst layer comprising noble metal on a second refractory metal oxide support;
b. coating said substrate with a top catalyst sub-layer comprising vanadia on a first refractory metal oxide support; and
c. subsequent to step (b), coating said substrate with a consecutive catalyst top sub-layer comprising said vanadia on said first refractory metal oxide support,
wherein said top sub-layers are applied over said bottom layer.

16. The method of claim 18, further comprising the step of calcining the catalyst article coated with the bottom layer and the top sub-layers at a temperature of about 400-600° C. for about 1-10 hours.

17. A catalyst article prepared by a process comprising the steps of:
a. coating a substrate with a bottom catalyst layer comprising noble metal on a second refractory metal oxide support;
b. coating said substrate with a top catalyst sub-layer comprising vanadia on a first refractory metal oxide support; and
c. subsequent to step (b), coating said substrate with a consecutive catalyst top sub-layer comprising said vanadia on said first refractory metal oxide support,
wherein said top sub-layers are applied over said bottom layer.

18. A method for treating an emission gas comprising:
a. contacting a emission gas derived combusting hydrocarbons in a stoichiometric excess of oxygen, wherein the emission gas contains ammonia, with a catalyst article of claim 1; and
b. oxidizing a least a portion of said ammonia to form N₂ and/or NOₓ.

19. The method of claim 18, further comprising:
c. selectively reducing NOx with an SCR catalyst in the presence of NH3, wherein said selectively reducing step occurs upstream of said contacting step.

20. The method of claim 18, wherein said oxidizing occurs at a temperature of about 350° C. to about 650° C.

21. The method of claim 20, wherein said oxidizing has less selectivity for NOₓ relative to NH₃.

22. The method of claim 21, wherein said oxidizing has selectivity for NOₓ that is less than half the selectivity for NH₃.

23. A system for treating an emission gas comprising an SCR catalyst and an ammonia slip catalyst of claim 1.
